(19) United States
(12) Patent Application Publication
(10) Pub. No.: US 2025/0301090 A1
(43) Pub. Date: Sep. 25, 2025

(54) INFORMATION PROCESSING APPARATUS, INFORMATION PROCESSING METHOD, NON-TRANSITORY COMPUTER-READABLE STORAGE MEDIUM STORING PROGRAM, AND INFORMATION PROCESSING SYSTEM

(71) Applicant: SEIKO EPSON CORPORATION, Tokyo (JP)

(72) Inventor: Tetsuya HORII, OKAYA-SHI (JP)

(21) Appl. No.: 19/081,695

(22) Filed: Mar. 17, 2025

(30) Foreign Application Priority Data
Mar. 19, 2024 (JP) 2024-043243

(51) Int. Cl. H04N 1/387; G06K 15/02; G09B 7/02; H04N 1/00

(52) U.S. Cl. CPC H04N 1/3877; G06K 15/1889; G09B 7/02; H04N 1/00005; H04N 1/00037; H04N 1/00076; H04N 1/00082; H04N 1/00344

(57) ABSTRACT

The information processing apparatus includes a scanned image data acquiring section that acquires filled-out teaching material image data indicating a filled-out teaching material image generated by an image forming apparatus reading a filled-out teaching material sheet. The information processing apparatus includes a scanned image data correcting section that corrects the filled-out teaching material image data in such a way that the orientation of the filled-out teaching material image becomes normal when the filled-out teaching material image data is a target of automatic scoring and the orientation of the filled-out teaching material image is not normal, and a scanned image data transmitting section that transmits the filled-out teaching material image data on the filled-out teaching material image having the normal orientation to the teaching material managing apparatus.

The present application is based on, and claims priority from JP Application Serial Number 2024-043243, filed Mar. 19, 2024, the disclosure of which is hereby incorporated by reference herein in its entirety.

### BACKGROUND

### 1. Technical Field

The present disclosure relates to an information processing apparatus, an information processing method, a program, and an information processing system.

### 2. Related Art

JP-A-2019-023673 discloses an automatic scoring apparatus that reads and scores a test teaching material in which answers are written by a learner in answer fields and additionally prints results of the scoring on the test teaching material itself.

JP-A-2019-023673 is an example of the related art.

The automatic scoring apparatus disclosed in JP-A-2019-023673 may not be capable of performing the automatic scoring when the orientation of the test teaching material being read deviates from a desired direction, resulting in poor convenience.

### SUMMARY

There is provided an information processing apparatus configured to communicate with a learning managing apparatus and an image forming apparatus, the information processing apparatus including:
a scanned image data acquiring section configured to acquire scanned image data indicating a scanned image generated by the image forming apparatus reading a print medium;
a first determination section configured to determine whether an orientation of the scanned image is normal;
a second determination section configured to determine whether the scanned image data is a target of automatic scoring;
a scanned image data correcting section configured to correct the scanned image data in such a way that the orientation of the scanned image becomes normal when the scanned image data is a target of the automatic scoring and the orientation of the scanned image is not normal; and
a scanned image data transmitting section configured to transmit the scanned image data on the scanned image having the normal orientation to the learning managing apparatus.

There is provided an information processing method for an information processing apparatus configured to communicate with a learning managing apparatus and an image forming apparatus, the method including:
acquiring scanned image data indicating a scanned image generated by the image forming apparatus reading a print medium;
determining whether an orientation of the scanned image is normal;
determining whether the scanned image data is a target of automatic scoring;
correcting the scanned image data in such a way that the orientation of the scanned image becomes normal when the scanned image data is a target of the automatic scoring and the orientation of the scanned image is not normal; and
transmitting the scanned image data on the scanned image having the normal orientation to the learning managing apparatus.

There is provided a program configured to cause an information processing apparatus configured to communicate with a learning managing apparatus and an image forming apparatus to function as:
a scanned image data acquiring section configured to acquire scanned image data indicating a scanned image generated by the image forming apparatus reading a print medium;
a first determination section configured to determine whether an orientation of the scanned image is normal;
a second determination section configured to determine whether the scanned image data is a target of automatic scoring;
a scanned image data correcting section configured to correct the scanned image data in such a way that the orientation of the scanned image becomes normal when the scanned image data is a target of the automatic scoring and the orientation of the scanned image is not normal; and
a scanned image data transmitting section configured to transmit the scanned image data on the scanned image having the normal orientation to the learning managing apparatus.

An information processing system including:
the information processing apparatus described above; and
the image forming apparatus described above.

### BRIEF DESCRIPTION OF THE DRAWINGS

FIG. 1 is a schematic view of an information processing system. (first embodiment)

FIG. 2 shows an example of a no-code-containing teaching material image. (first embodiment)

FIG. 3 shows an example of a code-containing teaching material image. (first embodiment)

FIG. 4 shows an example of a filled-out teaching material image. (first embodiment)

FIG. 5 is a block diagram of an information processing apparatus. (first embodiment)

FIG. 6 shows another example of the filled-out teaching material image. (first embodiment)

FIG. 7 is a sequence chart in accordance with which the information processing system operates. (first embodiment)

FIG. 8 is a schematic view of an information processing system. (second embodiment)

### DESCRIPTION OF EMBODIMENTS

Embodiments will be described below with reference to the drawings. To clarify the description, omission and simplification have been made as appropriate in the description and the drawings below. In the drawings, the same elements have the same reference characters, and no duplicated description of the same elements is made as required.

### First Embodiment

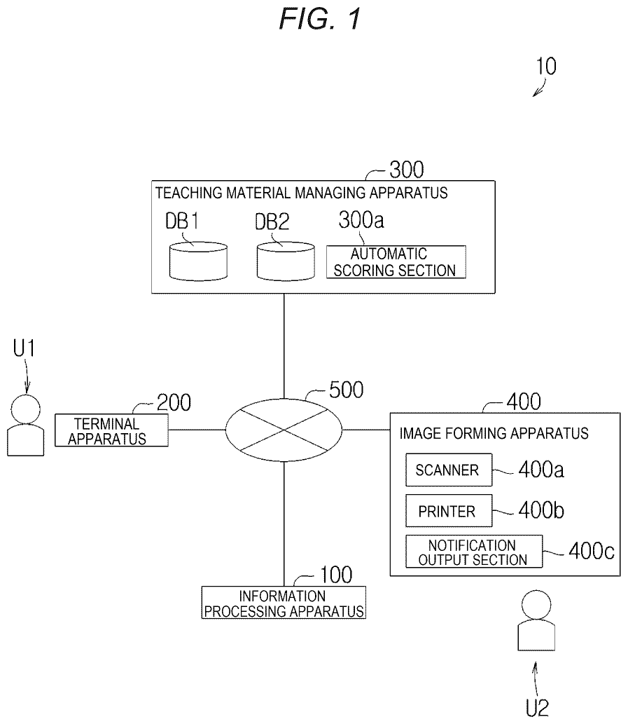

FIG. 1 is a block diagram showing an example of the configuration of an information processing system 10 according to a first embodiment. The information processing system 10 includes an information processing apparatus 100, a terminal apparatus 200, a teaching material managing apparatus 300, and an image forming apparatus 400, as shown in FIG. 1. The information processing apparatus 100, the terminal apparatus 200, the teaching material managing apparatus 300, and the image forming apparatus 400 are typically configured to perform bidirectional communication via a wide area network 500 (WAN).

Terms used in the present specification are defined below.

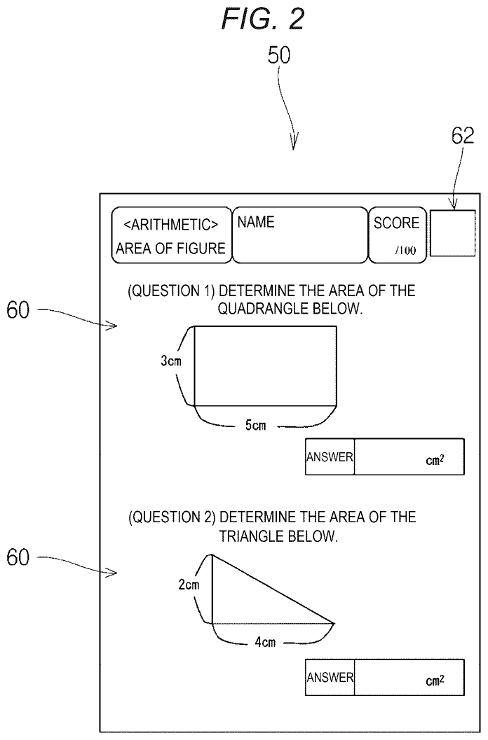

A “no-code-containing teaching material image” corresponds to FIG. 2 and is a teaching material image containing no code image.

“No-code-containing teaching material image data” is image data indicating a no-code-containing teaching material image.

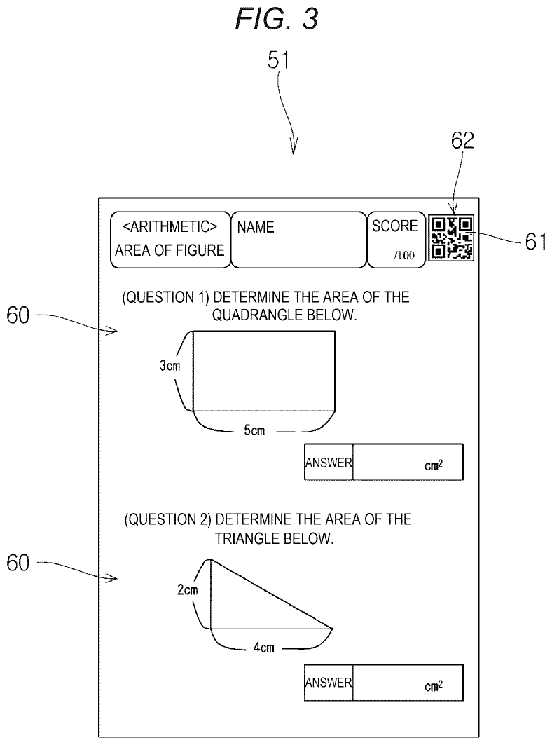

A “code-containing teaching material image” corresponds to FIG. 3 and is a teaching material image containing a code image.

“Code-containing teaching material image data” is image data indicating a code-containing teaching material image.

A “code-containing teaching material sheet” is a sheet having a code-containing teaching material image printed thereon.

A “filled-out teaching material sheet” is a sheet having answers written on a code-containing teaching material sheet.

“Filled-out teaching material image data” is image data generated by reading a filled-out teaching material sheet.

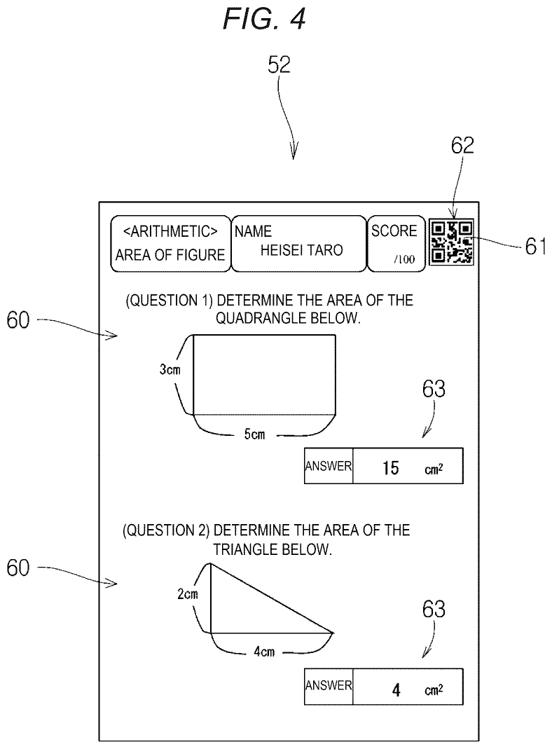

A “filled-out teaching material image” corresponds to FIG. 4, and is an image indicated by filled-out teaching material image data.

The “no-code-containing teaching material image”, the “code-containing teaching material image”, and the “filled-out teaching material image” are each simply referred to as a teaching material image in some cases.

The “code-containing teaching material sheet” and the “filled-out teaching material sheet” are each simply referred to as a teaching material sheet in some cases.

The “no-code-containing teaching material image data”, the “code-containing teaching material image data”, and the “filled-out teaching material image data” are each simply referred to as teaching material image data in some cases.

The teaching material sheet is a sheet having a teaching material printed thereon in the form of a teaching material image.

With reference back to FIG. 1, the terminal apparatus 200 is an apparatus operated by a user U1 and is, for example, a smartphone, a tablet terminal, or a personal computer. The user U1 is a manager who performs management including distributing a teaching material sheet to a user U2 and collecting the teaching material sheet from the user U2. Specifically, the user U1 is, for example, a teacher who teaches the user U2. The user U1 uses the terminal apparatus 200 to specify a teaching material to be distributed and a destination to which the teaching material is distributed. The teaching material is output in the form of a teaching material sheet from the image forming apparatus 400 and distributed to the user U2. The destination to which the teaching material is distributed is therefore specifically the image forming apparatus 400 set to print the teaching material. In the present embodiment, the user U1 notifies via the terminal apparatus 200 the teaching material managing apparatus 300 of a teaching material to be distributed and the image forming apparatus 400 set to print the teaching material. Note that FIG. 1 shows one terminal apparatus 200 and one user U1, but multiple users U1 can use the information processing system 10. The information processing system 10 can therefore include multiple terminal apparatuses 200.

The teaching material managing apparatus 300 is a specific example of a learning managing apparatus. The teaching material managing apparatus 300 is an apparatus that manages no-code-containing teaching material image data and filled-out teaching material image data. In the present embodiment, the teaching material managing apparatus 300 includes a first database DB1, which stores no-code-containing teaching material image data. The teaching material managing apparatus 300 further includes a second database DB2, which stores filled-out teaching material image data. In the present embodiment, when a teaching material to be distributed and the image forming apparatus 400 set to print the teaching material are specified via the terminal apparatus 200, the teaching material managing apparatus 300 transmits a print instruction to print the teaching material to the information processing apparatus 100. The print instruction may contain, for example, no-code-containing teaching material image data, apparatus identification information for identifying the image forming apparatus 400 set to print the teaching material, and additional information.

The additional information contains teaching material identification information for identifying a teaching material to be distributed, user identification information for identifying the user U2 who receives the teaching material, and automatic scoring target information indicating whether the teaching material is a target of automatic scoring.

The teaching material managing apparatus 300 receives filled-out teaching material image data from the information processing apparatus 100 and stores the data in the second database DB2.

The teaching material managing apparatus 300 further includes an automatic scoring section 300a. The automatic scoring section 300a acquires the filled-out teaching material image data from the second database DB2, performs image analysis on the filled-out teaching material image to determine whether the answers written on the filled-out teaching material sheet is correct or incorrect, and transmits the result of the determination to the terminal apparatus 200. The result of the determination is typically a score calculated based on the correct/incorrect determination. The result of the determination may instead be scored teaching material image data so generated by processing the filled-out teaching material image data that a correct/incorrect mark indicating correct/incorrect is superimposed on the filled-out teaching material sheet.

The teaching material managing apparatus 300 can be realized by a single apparatus. Note however that the teaching material managing apparatus 300 may instead be realized by distributed processing performed by multiple apparatuses as in a second embodiment described later.

The image forming apparatus 400 includes a scanner 400a having a reading function, a printer 400b having a printing function, and a notification output section 400c. The image forming apparatus 400 is also referred to as a multifunction machine. The image forming apparatus 400 may be realized by multiple apparatuses in pace of a multifunction machine that is the combination of the scanner 400a and the printer 400b integrated with each other. r. In this case, the multiple apparatuses include a scanner and a printer.

The image forming apparatus 400 is used by the user U2. The image forming apparatus 400 is typically provided in the residence of the user U2. FIG. 1 shows one image forming apparatus 400, but the information processing system 10 may include multiple image forming apparatuses 400 when multiple users U2 use the information processing system 10.

The printer 400b prints code-containing teaching material image data received from the information processing apparatus 100 to output a code-containing teaching material sheet. The printer 400b includes a printing engine. The printing engine is a mechanical configuration that prints an image on a print medium with coloring materials. The printing engine may include, for example, an inkjet mechanism that performs printing with ink. The printing engine may instead include, for example, an electrophotographic mechanism that performs printing with toner.

The user U2 uses the code-containing teaching material sheet output from the printer 400b. In particular, the user U2 typically writes answers by handwriting on the code-containing teaching material sheet for each question printed on the code-containing teaching material sheet.

The scanner 400a reads the filled-out teaching material sheet and generates filled-out teaching material image data. The scanner 400a reads the filled-out teaching material sheet by using a light source and a sensor in a predetermined direction, that is, a secondary scanning direction to optically read the filled-out teaching material sheet and generates filled-out teaching material image data. The image forming apparatus 400 transmits the filled-out teaching material image data along with the apparatus identification information for identifying the image forming apparatus 400 to the information processing apparatus 100.

The notification output section 400c is configured with a display apparatus, such as an organic light emitting diode (OLED) or a liquid crystal display (LCD). The notification output section 400c visually outputs notification received from the information processing apparatus 100 to the user U2 via the display apparatus. The notification output section 400c may instead be configured to audibly output the notification received from the information processing apparatus 100.

FIG. 2 shows a no-code-containing teaching material image 50. FIG. 3 shows a code-containing teaching material image 51. FIG. 4 shows a filled-out teaching material image 52. The no-code-containing teaching material image 50 includes multiple questions 60 to be solved by the user U2, as shown in FIG. 2. A space 62, to which a code image 61 is added, is provided at a predetermined position in the no-code-containing teaching material image 50, as shown in FIGS. 2 and 3. In the present embodiment, the predetermined position is an upper right end position of the no-code-containing teaching material image 50. Note however that the predetermined position may be a lower right end position, an upper left end position, or a lower left end position in the no-code-containing teaching material image 50. The predetermined position may still instead be the center of an upper end portion of the no-code-containing teaching material image 50 or the center of a lower end portion of the no-code-containing teaching material image 50. The code-containing teaching material image 51 is an image in which the code image 61 is superimposed on the space 62 of the no-code-containing teaching material image 50, as shown in FIG. 3. The printer 400b of the image forming apparatus 400 prints and outputs the code-containing teaching material image 51. The user U2 writes an answer 63 for each of the questions 60 on the code-containing teaching material image 51, as shown in FIG. 4. The scanner 400a of the image forming apparatus 400 reads the filled-out teaching material sheet, and transmits the filled-out teaching material image data to the information processing apparatus 100.

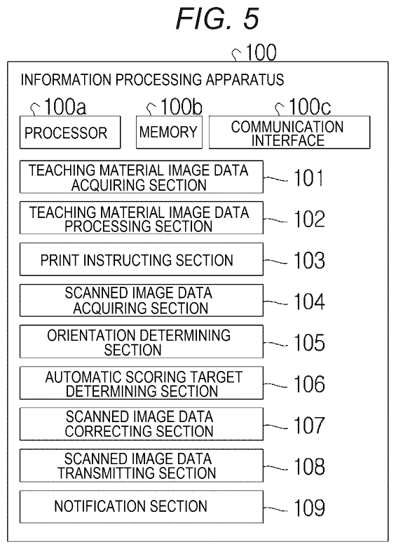

The information processing apparatus 100 will next be described with reference to FIG. 5. The information processing apparatus 100 includes a processor 100a, a memory 100b, and a communication interface 100c, as shown in FIG. 5. The memory 100b is realized by a ROM (read only memory), a RAM (random access memory), an HDD (hard disc drive), or an SSD (solid-state drive). The information processing apparatus 100 communicates with the teaching material managing apparatus 300, the image forming apparatus 400, and the like via the communication interface 100c. The processor 100a can access the memory 100b. The processor 100a reads and executes a program stored in the memory 100b. The program, when executed, causes the hardware such as the processor 100a to function as a teaching material image data acquiring section 101, a teaching material image data processing section 102, a print instructing section 103, a scanned image data acquiring section 104, an orientation determining section 105, an automatic scoring target determining section 106, a scanned image data correcting section 107, a scanned image data transmitting section 108, and a notification section 109.

The teaching material image data acquiring section 101 is a specific example of a printed image data acquiring section. The teaching material image data acquiring section 101 receives the print instruction from the teaching material managing apparatus 300. The print instruction may contain the no-code-containing teaching material image data corresponding to a teaching material to be distributed, the apparatus identification information for identifying the image forming apparatus 400 set to print the teaching material, and the additional information, as described above. The additional information contains the teaching material identification information for identifying a teaching material to be distributed, the user identification information for identifying the user U2 who receives the teaching material, and the automatic scoring target information indicating whether the teaching material is a target of the automatic scoring, as described above. The no-code-containing teaching material image is a specific example of a printed image.

The teaching material image data processing section 102 generates the code image 61 as a result of encoding the additional information described above. The code image 61 is typically a barcode or a two-dimensional code. Examples of the two-dimensional code may include a stack-type two-dimensional code and a matrix-type two-dimensional code. The matrix-type two-dimensional code is a QR code (registered trademark) or Data Matrix. In the present embodiment, a QR code is employed as the code image 61, as shown in FIG. 3. The teaching material image data processing section 102 processes the no-code-containing teaching material image 50 in such a way that the code image 61 is superimposed on the no-code-containing teaching material image 50 to generate the code-containing teaching material image 51, as shown in FIGS. 2 and 3. The code image 61 is a specific example of a first mark. The code image 61 is a specific example of a mark.

The print instructing section 103 identifies the image forming apparatus 400 to be instructed by the print instruction based on the apparatus identification information contained in the print instruction received from the teaching material managing apparatus 300, and instructs the image forming apparatus 400 to print the code-containing teaching material image 51.

The scanned image data acquiring section 104 receives and acquires filled-out teaching material image data from the image forming apparatus 400.

The orientation determining section 105 determines whether the orientation of the filled-out teaching material image 52 is normal based on the filled-out teaching material image data.

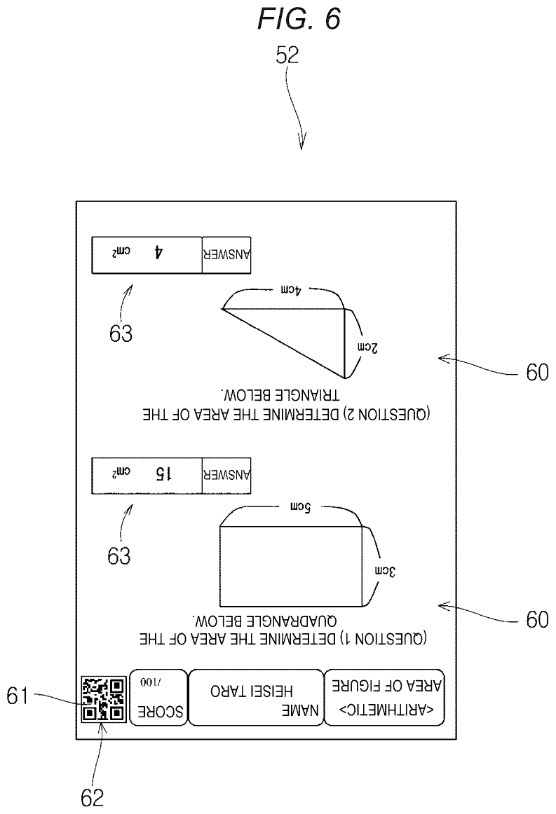

For example, the orientation determining section 105 can detect the code image 61 contained in the filled-out teaching material image 52 and determine whether the orientation of the filled-out teaching material image 52 is normal based on the position of the detected code image 61 in the filled-out teaching material image 52. The teaching material image data processing section 102 has superimposed the code image 61 on the upper right end portion of the no-code-containing teaching material image 50, as described above. Therefore, when the code image 61 is located at the upper right end portion of the filled-out teaching material image 52, the orientation determining section 105 determines that the orientation of the filled-out teaching material image 52 is normal. In contrast, for example, when the code image 61 is not located at the upper right end potion of the filled-out teaching material image 52, that is, typically, when the code image 61 is located at a lower left end portion of the filled-out teaching material image 52, as shown in FIG. 6, the orientation determining section 105 determines that the orientation of the filled-out teaching material image 52 is not normal.

Furthermore, for example, the orientation determining section 105 can compare the filled-out teaching material image 52 with the code-containing teaching material image 51, and determine whether the orientation of the filled-out teaching material image is normal based on a difference image indicating a difference between the two images. When the number of pixels that indicates the difference out of the multiple pixels that constitute the difference image is smaller than a predetermined number, the orientation determining section 105 determines that the orientation of the filled-out teaching material image 52 is normal. On the other hand, when the number of pixels that indicates the difference out of the multiple pixels that constitute the difference image is greater than or equal to the predetermined number, the orientation determining section 105 determines that the orientation of the filled-out teaching material image 52 is not normal.

The automatic scoring target determining section 106 determines whether the filled-out teaching material image data is a target of the automatic scoring performed by the automatic scoring section 300a of the teaching material managing apparatus 300. In other words, the automatic scoring target determining section 106 determines whether the teaching material corresponding to the filled-out teaching material image data is a target of the automatic scoring performed by the automatic scoring section 300a of the teaching material managing apparatus 300.

For example, the automatic scoring target determining section 106 detects the code image 61 contained in the filled-out teaching material image 52 and decodes the detected code image 61 to acquire the additional information. The additional information contains the automatic scoring target information indicating whether the corresponding teaching material is a target of the automatic scoring, as described above. In other words, it can be said that the additional information contains the automatic scoring target information indicating whether the filled-out teaching material image data is a target of the automatic scoring. The automatic scoring target determining section 106 can therefore determine whether the filled-out teaching material image data is a target of the automatic scoring performed by the automatic scoring section 300a of the teaching material managing apparatus 300 based on the automatic scoring target information acquired by decoding the code image 61.

Furthermore, for example, the automatic scoring target determining section 106 can determine whether the filled-out teaching material image 52 indicated by the filled-out teaching material image data contains a multiple choice question by performing image analysis on the filled-out teaching material image 52, and can determine based on the result of the determination whether the filled-out teaching material image data is a target of the automatic scoring performed by the automatic scoring section 300a of the teaching material managing apparatus 300. The multiple choice question used herein typically means a question to be answered in a mark sheet format, a question to be answered with one alphabet or one numeral, or a question to be answered without writing a sentence. When a multiple choice question is contained in the filled-out teaching material image 52, the automatic scoring target determining section 106 determines that the filled-out teaching material image data is a target of the automatic scoring performed by the automatic scoring section 300a of the teaching material managing apparatus 300. On the other hand, when the filled-out teaching material image 52 does not contain a multiple choice question, the automatic scoring target determining section 106 determines that the filled-out teaching material image data is not a target of the automatic scoring performed by the automatic scoring section 300a of the teaching material managing apparatus 300.

When the filled-out teaching material image data is a target of the automatic scoring and the orientation of the filled-out teaching material image is not normal, the scanned image data correcting section 107 corrects the filled-out teaching material image data in such a way that the orientation of the filled-out teaching material image 52 becomes normal.

Specifically, when the code image 61 is located at a lower left end portion of the filled-out teaching material image 52, the scanned image data correcting section 107 corrects the filled-out teaching material image data in such a way that the code image 61 is located at the upper right end portion of the filled-out teaching material image 52, that is, the filled-out teaching material image 52 is rotated by 180 degrees. Correcting the orientation of the filled-out teaching material image 52 to the normal orientation as described above allows the automatic scoring section 300a of the teaching material managing apparatus 300 to perform the automatic scoring without any problem.

Note that when the orientation of the filled-out teaching material image 52 is normal, the scanned image data correcting section 107 does not correct the filled-out teaching material image data. This is because when the orientation of the filled-out teaching material image 52 has been already normal, it is not necessary to change the orientation of the filled-out teaching material image 52.

Furthermore, even when the orientation of the filled-out teaching material image 52 is not normal, but when the filled-out teaching material image data is not a target of the automatic scoring, the scanned image data correcting section 107 does not correct the filled-out teaching material image data. This is because the correction made by the scanned image data correcting section 107 is performed to allow the automatic scoring section 300a of the teaching material managing apparatus 300 to perform the automatic scoring without any problem.

The scanned image data transmitting section 108 transmits the filled-out teaching material image data on the filled-out teaching material image 52 having the normal orientation to the teaching material managing apparatus 300. The phrase “the filled-out teaching material image data on the filled-out teaching material image 52 having the normal orientation” includes filled-out teaching material image data that has been corrected by the scanned image data correcting section 107 and filled-out teaching material image data that has not been corrected by the scanned image data correcting section 107 because the orientation of the filled-out teaching material image 52 is normal in the first place.

When the orientation of the filled-out teaching material image is not normal and the filled-out teaching material image data is not a target of the automatic scoring, the notification section 109 notifies the user U2 via the image forming apparatus 400 that the orientation of the filled-out teaching material sheet was not normal when the image forming apparatus 400 read the filled-out teaching material sheet.

Specifically, when the orientation of the filled-out teaching material image 52 is not normal and the filled-out teaching material image data is not a target of the automatic scoring, the notification section 109 transmits, to the image forming apparatus 400, a notification instruction that instructs the image forming apparatus 400 to notify the user U2 that the orientation of the filled-out teaching material sheet was not normal when the image forming apparatus 400 read the filled-out teaching material sheet. When the image forming apparatus 400 receives the notification instruction from the information processing apparatus 100, the image forming apparatus 400 notifies in accordance with the notification instruction the user U2 via the notification output section 400c that the orientation of the filled-out teaching material sheet was not normal when the image forming apparatus 400 read the filled-out teaching material sheet.

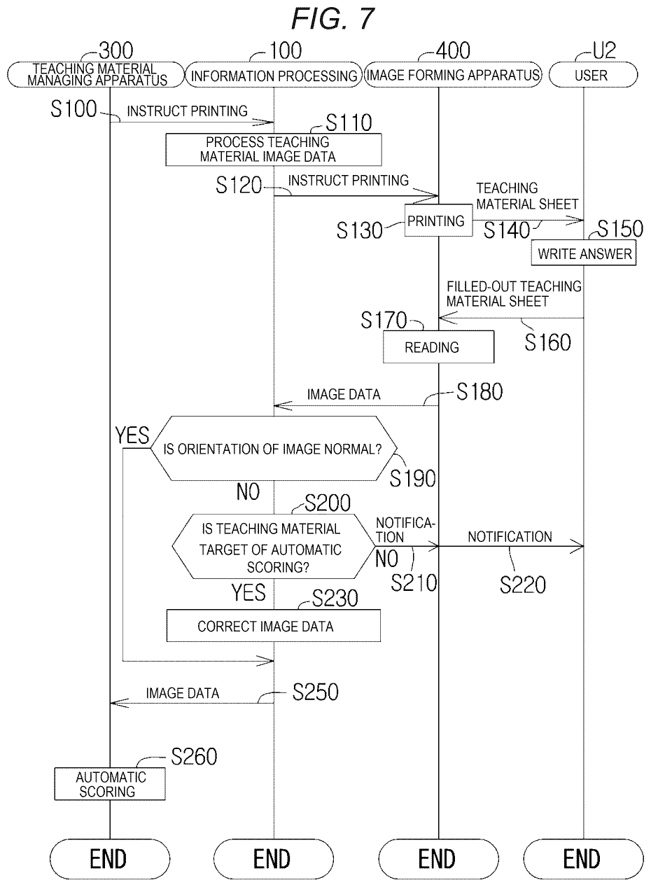

The procedure of the operation of the information processing system 10 will next be described with reference to FIG. 7. FIG. 7 is a sequence chart in accordance with which the information processing system 10 operates.

When a teaching material to be distributed and the image forming apparatus 400 set to print the teaching material are specified via the terminal apparatus 200, the teaching material managing apparatus 300 transmits the print instruction to the information processing apparatus 100 (S100). The teaching material image data acquiring section 101 of the information processing apparatus 100 acquires no-code-containing teaching material image data contained in the print instruction received from the teaching material managing apparatus 300 (S100).

The teaching material image data processing section 102 then processes the no-code-containing teaching material image 50 in such a way that the code image 61 is superimposed on the no-code-containing teaching material image (S110) to generate the code-containing teaching material image 51, as shown in FIGS. 2 and 3. The print instructing section 103 then instructs the image forming apparatus 400 to print the code-containing teaching material image (S120). The printer 400b of the image forming apparatus 400 then prints the code-containing teaching material image (S130).

The user U2 then receives a code-containing teaching material sheet printed by and output from the printer 400b of the image forming apparatus 400 (S140), and writes answers on the code-containing teaching material sheet (S150). The user U2 sets the filled-out teaching material sheet at the scanner 400a of the image forming apparatus 400 (S160). The scanner 400a of the image forming apparatus 400 thus reads the filled-out teaching material sheet (S170), and generates filled-out teaching material image data.

The image forming apparatus 400 then transmits the filled-out teaching material image data to the information processing apparatus 100 (S180). The scanned image data acquiring section 104 of the information processing apparatus 100 receives and acquires the filled-out teaching material image data from the image forming apparatus 400 (S180).

The orientation determining section 105 then determines whether the orientation of the filled-out teaching material image is normal based on the filled-out teaching material image data (S190). When the orientation determining section 105 determines that the orientation of the filled-out teaching material image is normal (YES in S190), the orientation determining section 105 advances the process to step S250. On the other hand, when the orientation determining section 105 determines that the orientation of the filled-out teaching material image is not normal (NO in S190), the orientation determining section 105 advances the process to step S200.

The automatic scoring target determining section 106 then determines whether the filled-out teaching material image data is a target of the automatic scoring performed by the automatic scoring section 300a of the teaching material managing apparatus 300 (S200). When the automatic scoring target determining section 106 determines that the filled-out teaching material image data is a target of the automatic scoring performed by the automatic scoring section 300a of the teaching material managing apparatus 300 (YES in S200), the automatic scoring target determining section 106 advances the process to step S230. On the other hand, when the automatic scoring target determining section 106 determines that the filled-out teaching material image data is not a target of the automatic scoring performed by the automatic scoring section 300a of the teaching material managing apparatus 300 (NO in S200), the notification section 109 transmits, to the image forming apparatus 400, a notification instruction that instructs the image forming apparatus 400 to notify the user U2 that the orientation of the filled-out teaching material sheet was not normal when the image forming apparatus 400 read the filled-out teaching material sheet (S210). When the image forming apparatus 400 receives the notification instruction from the information processing apparatus 100 (S210), the image forming apparatus 400 notifies in accordance with the notification instruction the user U2 via the notification output section 400c that the orientation of the filled-out teaching material sheet was not normal when the image forming apparatus 400 read the filled-out teaching material sheet (S220). In response to the notification, the user U2 sets the filled-out teaching material sheet again at the scanner 400a of the image forming apparatus 400 while paying attention to the orientation of the filled-out teaching material sheet (S160).

In step S230, the scanned image data correcting section 107 corrects the filled-out teaching material image data in such a way that the orientation of the filled-out teaching material image becomes normal (S230). The scanned image data transmitting section 108 then transmits the filled-out teaching material image data on the filled-out teaching material image 52 having the normal orientation to the teaching material managing apparatus 300 (S250). The teaching material managing apparatus 300 stores the filled-out teaching material image data received from the information processing apparatus 100 in the second database DB2 (S250), determines whether the answers written on the filled-out teaching material sheet are each correct or incorrect by performing image analysis on the filled-out teaching material image indicated by the filled-out teaching material image data (S260), and transmits the result of the determination to the terminal apparatus 200.

The first embodiment has been described above, and the embodiment described above has the features below.

The information processing apparatus 100 can communicate with the teaching material managing apparatus 300 (learning managing apparatus) and the image forming apparatus 400. The information processing apparatus 100 includes the scanned image data acquiring section 104, which acquires filled-out teaching material image data (scanned image data) indicating the filled-out teaching material image 52 (scanned image) generated by the image forming apparatus 400 reading a filled-out teaching material sheet (print medium). The information processing apparatus 100 includes the orientation determining section 105 (first determination section), which determines whether the orientation of the filled-out teaching material image 52 is normal, and the automatic scoring target determining section 106 (second determination section), which determines whether the filled-out teaching material image data is a target of the automatic scoring performed by the automatic scoring section 300a of the teaching material managing apparatus 300. The information processing apparatus 100 includes the scanned image data correcting section 107, which corrects the filled-out teaching material image data in such a way that the orientation of the filled-out teaching material image 52 becomes normal when the filled-out teaching material image data is a target of the automatic scoring and the orientation of the filled-out teaching material image 52 is not normal, and the scanned image data transmitting section 108, which transmits the filled-out teaching material image data on the filled-out teaching material image 52 having the normal orientation to the teaching material managing apparatus 300. According to the configuration described above, the automatic scoring performed by the automatic scoring section 300a of the teaching material managing apparatus 300 is performed without any problem, resulting in improved convenience.

The code-containing teaching material sheet is a sheet having the code image 61 (first mark) printed thereon at the upper right end portion (first position). When the code image 61 is not located at the upper right end portion of the filled-out teaching material image 52, the orientation determining section 105 determines that the orientation of the filled-out teaching material image 52 is not normal. According to the configuration described above, only detecting the code image 61 in the filled-out teaching material image 52 allows determination of whether the orientation of the filled-out teaching material image 52 is normal without any involvement of complicated calculation.

The scanned image data correcting section 107 corrects the filled-out teaching material image data in such a way that the code image 61 is located at the upper right end portion of the filled-out teaching material image 52. According to the configuration described above, the automatic scoring performed by the automatic scoring section 300a of the teaching material managing apparatus 300 is performed without any problem.

The filled-out teaching material sheet is a sheet having the code image 61 printed thereon. The code image 61 is a mark that can be decoded to show the automatic scoring target information indicating whether a filled-out teaching material sheet is a target of the automatic scoring. The automatic scoring target determining section 106 decodes the code image 61 contained in the filled-out teaching material image 52 to determine whether the filled-out teaching material image data is a target of the automatic scoring. According to the configuration described above, the automatic scoring target determining section 106 can accurately determine based on the code image 61 whether the filled-out teaching material image data is a target of the automatic scoring.

The information processing apparatus 100 further includes the notification section 109, which notifies, when the filled-out teaching material image data is not a target of the automatic scoring and the orientation of the filled-out teaching material image 52 is not normal, via the image forming apparatus 400 that the orientation of the filled-out teaching material sheet is not normal when the filled-out teaching material sheet is read. According to the configuration described above, the user U2 is so notified that the scanner 400a can read the filled-out teaching material image 52 in the normal direction.

The information processing apparatus 100 further includes the teaching material image data acquiring section 101 (printed image data acquiring section), which acquires no-code-containing teaching material image data (printed image data) indicating the no-code-containing teaching material image 50 (printed image) from the teaching material managing apparatus 300, the teaching material image data processing section 102 (printed image data processing section), which processes the no-code-containing teaching material image data in such a way that the code image 61 (mark) is superimposed on the no-code-containing teaching material image 50, and the print instructing section 103, which instructs the image forming apparatus 400 to print the code-containing teaching material image data generated by the teaching material image data processing section 102 processing the no-code-containing teaching material image data. The configuration described above can cause the image forming apparatus 400 to print the code-containing teaching material image 51, which is the no-code-containing teaching material image 50 having the code image 61 superimposed thereon.

The mark described above can be decoded to show information indicating whether the no-code-containing teaching material image data is a target of the automatic scoring. The configuration described above allows determination of whether the teaching material image data is a target of the automatic scoring based on the mark.

When the orientation of the filled-out teaching material image 52 is normal, the scanned image data correcting section 107 does not correct the filled-out teaching material image data. According to the configuration described above, when the orientation of the filled-out teaching material image 52 is normal, the orientation of the filled-out teaching material image 52 is not changed.

When the filled-out teaching material image 52 contains a multiple choice question, the automatic scoring target determining section 106 determines that the filled-out teaching material image data is a target of the automatic scoring. The configuration described above allows determination of whether the filled-out teaching material image data is a target of the automatic scoring even when the code image 61 has not been superimposed on the filled-out teaching material image 52, the code image 61 has not been successfully read, or the code image 61 has not been successfully decoded.

### Second Embodiment

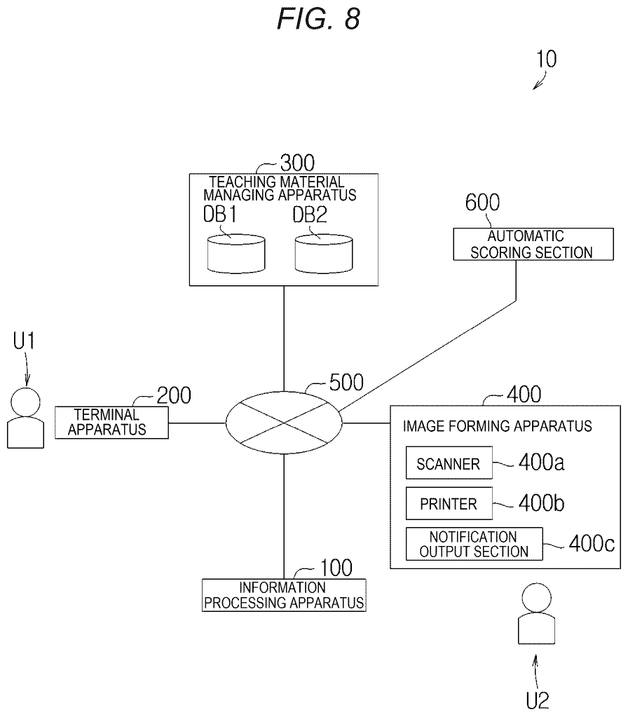

A second embodiment will next be described with reference to FIG. 8. Differences between the present embodiment and the first embodiment will be primarily described below, and no redundant description will be made.

In the first embodiment described above, the teaching material managing apparatus 300 includes the automatic scoring section 300a. In contrast, the teaching material managing apparatus 300 does not include the automatic scoring section 300a in the present embodiment. The information processing system 10 further includes an automatic scoring apparatus 600.

The teaching material managing apparatus 300 transmits filled-out teaching material image data received from the information processing apparatus 100 to the automatic scoring apparatus 600, which provides an automatic scoring service. The automatic scoring apparatus 600 performs image analysis on an filled-out teaching material image indicated by the filled-out teaching material image data received from the teaching material managing apparatus 300 to determine whether answers written on the filled-out teaching material sheet are each correct or incorrect, and transmits the result of the determination to the teaching material managing apparatus 300. The teaching material managing apparatus 300 transfers the result of the determination received from the automatic scoring apparatus 600 to the terminal apparatus 200.

As described above, the teaching material managing apparatus 300 itself may provide the automatic scoring service, or the automatic scoring apparatus 600, which is an apparatus separate from the teaching material managing apparatus 300, may provide the automatic scoring service.

In the example described above, the program can be stored on various types of non-transitory computer readable medium and supplied to a computer. The non-transitory computer readable medium include various types of tangible storage media. Examples of the non-transitory computer readable medium include a magnetic recording medium (flexible disk, magnetic tape, and hard disk drive, for example), and a magneto-optical recording medium (magneto-optical disk, for example). Examples of the non-transitory computer readable medium further include a CD-ROM (read only memory), a CD-R, a CD-R/W, and a semiconductor memory (including mask ROM, for example). Examples of the non-transitory computer readable medium still further include a programmable ROM (PROM), an erasable PROM (EPROM), a flash ROM, and a random access memory (RAM). The program may be supplied to the computer via various types of transitory computer readable medium. Examples of the transitory computer readable medium include an electric signal, an optical signal, and an electromagnetic wave. The transitory computer readable medium can supply the computer with the program via a wired communication path, such as an electric wire and an optical fiber, or a wireless communication path.

The embodiments have been described above, but the present disclosure is not limited to the embodiments described above and can be changed as appropriate to the extent that the changed embodiments do not depart from the intent of the present disclosure. For example, a document to be printed and read is a teaching material in the embodiments described above, and a document other than a teaching material may be specified as the document to be printed and read.

What is claimed is:

1. An information processing apparatus configured to communicate with a learning managing apparatus and an image forming apparatus, the information processing apparatus comprising:
a scanned image data acquiring section configured to acquire scanned image data indicating a scanned image generated by the image forming apparatus reading a print medium;
a first determination section configured to determine whether an orientation of the scanned image is normal;
a second determination section configured to determine whether the scanned image data is a target of automatic scoring;
a scanned image data correcting section configured to correct the scanned image data in such a way that the orientation of the scanned image becomes normal when the scanned image data is a target of the automatic scoring and the orientation of the scanned image is not normal; and
a scanned image data transmitting section configured to transmit the scanned image data on the scanned image having the normal orientation to the learning managing apparatus.

2. The information processing apparatus according to claim 1, wherein
the print medium has a first mark printed thereon at a first position, and
the first determination section is configured to determine that the orientation of the scanned image is not normal when the first mark is not located at the first position in the scanned image.

3. The information processing apparatus according to claim 2, wherein
the scanned image data correcting section is configured to correct the scanned image data in such a way that the first mark is brought to the first position in the scanned image.

4. The information processing apparatus according to claim 1, wherein
the print medium has a first mark printed thereon,
the first mark is a mark configured to be decoded to show information indicating whether the print medium is a target of the automatic scoring, and
the second determination section is configured to determine whether the scanned image data is a target of the automatic scoring by decoding the first mark contained in the scanned image.

5. The information processing apparatus according to claim 1, further comprising
a notification section configured to, when the scanned image data is not a target of the automatic scoring and the orientation of the scanned image is not normal, notify via the image forming apparatus that the orientation of the print medium is not normal when the print medium is read.

6. The information processing apparatus according to claim 1, further comprising:
a printed image data acquiring section configured to acquire printed image data indicating a printed image from the learning managing apparatus;
a printed image data processing section configured to process the printed image data in such a way that a mark is superimposed on the printed image; and
a print instructing section configured to instruct the image forming apparatus to print the printed image data processed by the printed image data processing section.

7. The information processing apparatus according to claim 6, wherein
the mark is configured to be decoded to show information indicating whether the printed image data is a target of the automatic scoring.

8. The information processing apparatus according to claim 1, wherein
the scanned image data correcting section is configured not to correct the scanned image data when the orientation of the scanned image is normal.

9. The information processing apparatus according to claim 1, wherein
the second determination section is configured to determine that the scanned image data is a target of the automatic scoring when the scanned image contains a multiple choice question.

10. An information processing method for an information processing apparatus configured to communicate with a learning managing apparatus and an image forming apparatus, the method comprising:
acquiring scanned image data indicating a scanned image generated by the image forming apparatus reading a print medium;
determining whether an orientation of the scanned image is normal;
determining whether the scanned image data is a target of automatic scoring;
correcting the scanned image data in such a way that the orientation of the scanned image becomes normal when the scanned image data is a target of the automatic scoring and the orientation of the scanned image is not normal; and
transmitting the scanned image data on the scanned image having the normal orientation to the learning managing apparatus.

11. A non-transitory computer-readable storage medium storing a program configured to cause an information processing apparatus configured to communicate with a learning managing apparatus and an image forming apparatus to function as:
a scanned image data acquiring section configured to acquire scanned image data indicating a scanned image generated by the image forming apparatus reading a print medium;
a first determination section configured to determine whether an orientation of the scanned image is normal;
a second determination section configured to determine whether the scanned image data is a target of automatic scoring;
a scanned image data correcting section configured to correct the scanned image data in such a way that the orientation of the scanned image becomes normal when the scanned image data is a target of the automatic scoring and the orientation of the scanned image is not normal; and
a scanned image data transmitting section configured to transmit the scanned image data on the scanned image having the normal orientation to the learning managing apparatus.

12. An information processing system according to claim 1 comprising;
the information processing apparatus; and
the image forming apparatus.
